(19) United States
(12) Patent Application Publication
(10) Pub. No.: US 2007/0067214 A1
(43) Pub. Date: Mar. 22, 2007

(54) System and method for purchasing and distributing remnant media and media advertising

(76) Inventors: Michael Caprio, Wyckoff, NJ (US); Charles Omphalius, Hopewell JCT, NY (US)

Correspondence Address: WEISS & WEISS, Suite 251, 300 Old Country Road, Mineola, NY, 11501, US

(21) Appl. No.: 11/525,313

(22) Filed: Sep. 22, 2006

Related U.S. Application Data
(60) Provisional application No. 60/719,638, filed on Sep. 22, 2005.

(51) Int. Cl. G06F 11/34

(52) U.S. Cl. 705/11

(57) ABSTRACT

A system and method for distributing remnant media.

### FIELD OF THE INVENTION

The present invention relates to a system and method for distributing remnant media.

### BACKGROUND OF THE INVENTION

US Pub No. 2002/0194215 relates to a system and method for provisioning an advertising application for publishers. The advertising application provides advertisers with the tools to generate and control an advertising campaign.

US Pub No. 2003/0070167 relates to a computer program product which enables automation and control of the sales, management, accounting, reporting, and traffic functions necessary to manage advertisement sales, content management, and administrative processes for media production environments, including television, radio and webcasting stations and newspaper. Distribution and tracking is enabled for both local and national advertisement and content management, whereby data, advertisements, content, and reports are pushed and pulled from individual nodes (e.g., television stations) to a central network hub or point that feeds and/or gathers data and communicates with the individual nodes. Traditional broadcast methods for over-the-air, DBS, terrestrial cable, wireless, and live Internet webcasting are combined with on-demand Internet and wireless appliances for monetizing and streamlining the sales, management, accounting, reporting, and traffic processes for single and multi-distribution content production environments.

US Pub No. 2001/0049824 relates to an Internet business model for conducting distribution of audio and multimedia programs, including the buying and selling of the advertisement space in the programs, integrating the selected ads into the programs, and distributing them to the listeners/viewers, using the Internet. The method includes techniques for accounting for royalties and fees associated with the distribution of the programming content as well as an open market for ad slot pricing based on consumer demand.

US Pub No. 2002/0107787 relates to a system for trading media space which includes a server node which receives requests for media space from buyers and offers of media space from sellers. The server node includes a set of rules for matching one of the requests and one of the offers to form a matched request and offer pair. A delivery system is connected to said server node for facilitating delivery of media content between the buyer and seller of the matched pair.

U.S. Pat. No. 6,832,207 relates to a super-saturation method for information-media relating to a three-body cooperation to direct information to an electronic media consumer. The invention facilitates a first media body substantially offering out of context information placement using a second cooperating media body. A facilitator body preferably guarantees that a consumer of the second media is a known consumer of the first media. The second media body presents an out of context information placement.

U.S. Pat. No. 6,567,824 relates to a method for inventory management which includes an initial step of receiving a customer request for an inventory item and then generating a table or menu of one or more inventory items that most closely correspond to the customer request using a price forecasting system. Based on negotiations concerning price, timing and other typical concerns, an item is selected from the table and a price quotation associated with the selected inventory item is generated using the price forecasting system, which price quotation has been predetermined by a yield management system using a pricing strategy. The customer information associated with the customer request is input into a traffic billing system. Information needed for price recalculation associated with the customer request is input into the yield management system. The yield management system recalculates pricing data with in a manner consistent with a pricing strategy implemented by the yield management system, so that price changes caused by a reduction in available inventory due to the customer request are taken into account, and pricing data accessed by the price forecasting system when a price quotation is generated is updated prior to repeating the process for a subsequent customer request.

U.S. Pat. No. 6,260,047 relates to a method for selecting an optimum time period from an inventory of available time periods, where each time period has a predetermined duration including selected and unselected time portions and an associated cost includes determining the total amount of time in each time period and the total amount of unselected time in each time period. A calculation is made for each time period to generate an inventory utilization index ratio based upon the total amount of time in each time period divided by the total amount of unselected time remaining in each time period. A table is prepared for all time periods in the inventory ranked numerically by the inventory utilization index ratio. A cost range is determined for each of the costs associated with each of the time periods. The table of time periods in the inventory is revised by removing time periods from the inventory which are not within the desired cost range. A time period is selected from the table based upon the ranking of the time period. Information related to the selected time period is stored as containing selected time in the time period inventory.

U.S. Pat. Nos. 6,253,187 and 6,061,691 and US Pub No. 2004/0236794 relate to a method for inventory management which includes an initial step of receiving a customer request for an inventory item and then generating a table or menu of one or more inventory items that most closely correspond to the customer request using a price forecasting system. Based on negotiations concerning price, time and other typical concerns, an item is selected from the table and a price quotation associated with the selected inventory item is generated using the price forecasting system, which price quotation has been determined by a yield management system using a pricing strategy.

US Pub No. 2003/0154142 relates to a an electronic data-mart or central information storage and data processing system is established to collect influencing factors for the probability and price sensitivity of a particular advertising buyer.

US Pub No. 2004/0186776 relates to a system and method of distributing advertisements to a medium. The method comprises classifying a plurality of messages according to a target criterion, selecting a message from the plurality of messages using a selection criterion, and delivering the selected message to a content site comprising a medium adapted to display a corresponding advertisement of the message. The selection criterion comprises a cost associated with the message.

US Pub No. 2004/0068435 relates to a method for automated management of Internet advertising campaigns. The method facilitates and automates the services and exchange of information between the publisher and the advertiser. The method implores an Ad Manager having a customized proactive reporting, which enables the client to conduct queries online as to the current status of the online Ad campaign.

US Pub No. 2002/0194215 relates to a system and method for provisioning an advertising application for publishers. The system provides tools to generate and control an advertising campaign.

US Pub No. 2004/0193488 relates to a method and system for statistics based individualized advertising over a network in which an advertiser provides to a content distributor one or more constraints defining the characteristics of desired target users and the manner by which the advertisement is to be delivered.

US Pub No. 2003/0225629 relates to a system for providing an interface that allows access to system used to sell time slots for advertisements in broadcast programming. The system allows a user to access databases to access information needed to sell the advertisements.

US Pub No. 2003/0046150 relates to a system and method of delivering multimedia content and advertising provides a remote user with the ability to order customized media and advertising via a physical media or broadband network.

US Pub No. 2002/0007308 relates to a system and method for placing advertisements with media organizations comprising making use of an electronic database; advertisers accessing the database so as to place offers for an advertising campaign in the database; media users accessing the database to review offers; accepting or declining the offer; placing orders for advertising specified by the campaign if an offer is accepted; determining when the advertisements have been run; and transferring funds from the advertisers to the media organization when the advertisements have been run.

In the past remnant radio has been limited to companies that purchase remnant media via telephone, fax and regular mail or use technology to set up media auctions on a posting board level with no collaborative tools to facilitate the buying process or eliminate the need for buyers and sellers.

Most companies in the media distribution business want to sell their advertising space, in advance and at a high rate. But if they cannot sell their space in advance, they will sell the space at a much reduced price.

### SUMMARY OF THE INVENTION

The present invention relates to a system and method for allowing a company to provide their unused advertising space to a potential advertiser who can then choose to advertise in that space. It is an object of the present invention to allow an advertiser to pick the markets that they wish to advertise in. It is an object of the present invention to allow an advertiser to choose the demographics they wish to advertise in. It is an object of the present invention to allow an advertiser to pick the price they wish to pay for their advertising.

It is an object of the present invention to take the unsold advertising space in radio, print, television, newspapers, billboards and similar unsold space and provide it to advertisers.

It is an object of the present invention to create a product profile for the advertiser that is based on the advertiser's product, target and return on investment goals. With regards to radio or television, the advertisement is only available for distribution on stations that satisfy the criteria of the advertiser. It is an object of the present invention to provide a cost per order model.

It is an object of the present invention to match advertiser marketing criteria with station profiles.

The present invention allows a radio or television station to log on to a website, and see the offer and the product shown by the advertiser. The station compares what their unsold time costs versus the offered cost per thousand (CPM) against the target demo. The stations can print the order, download the produced creative (or script) from the web site and air the commercials.

It is an object of the present invention to provide the advertisers with invoices and examine affidavits created by the media distribution centers. It is an object of the present invention to provide complete results analysis to the advertiser.

The present invention relates to a web-based tool that identifies unsold commercial inventory relating to advertising space. It is an object of the present invention to identify the unsold inventory for local stations, market clusters, a region or nationally.

It is an object of the present invention to provide the advertiser on a daily basis information regarding what advertisement is running and where. It is an object of the present invention to provide the information via a wireless means, including but not limited to e-mail.

It is an object of the present invention for the web site to earn their fee by receiving commissions from the companies selling their space as an agency commission.

It is an object of the present invention to provide a return on investment report to the advertisers.

It is an object of the present invention to present offers to purchase unsold advertising to local sales management on a daily basis on behalf of it's advertisers. The delivery system fulfills the need for media companies to generate last minute incremental revenue for perishable advertising inventory before it expires, as well as to remove the expense (commissions) of station representatives, and salespeople from the cost of sale.

The present invention is a web-based software interface utilizing a database platform which includes information on every licensed commercial radio station in the United States, powered by the industry standard Radio Data Trak and its parent M Street Corp.

It is an object of the present invention to create an infinite number of unwired networks of radio stations based on several different criteria specific to the needs of the advertiser.

The present invention provides a system, which fully automates the sale of remnant media by incorporating research, delivering contracts, reconciliation of accounting process, tracking sales performance of each station, and delivery of the advertisement itself.

It is an object of the present invention to allow advertisers to purchase spot radio on an unwired network basis. It is an object of the present invention to automate the buying and research elements by infusing market research data, as well as through the database supplied by Radio DataTrak. It is an object of the present invention to create a viable return on investment model.

### BRIEF DESCRIPTION OF THE DRAWINGS

FIG. 1 shows a flow chart illustrating and embodiment of the present invention.

### DETAILED DESCRIPTION OF THE INVENTION

Advertisers create a market profile and determine a prospective list of the stations to which they can offer to buy remnant, unsold, or perishable advertising inventory. Advertisers determine a rate per thousand (CPM) based on viewers, listeners, subscribers or participants that they are willing to pay for unsold advertising inventory. The applicable rate is offered to stations meeting their market profile. Sales management receives an email notifying them that a prospective client is interested in purchasing their unsold advertising inventory, and asking them to log-on with their unique user name and password. Once sales management agrees to the rate offered on behalf of the advertiser, established by the web database provider, the space owner can sell their unsold inventory, download the commercial, print the contract for the broadcast insertion order and create an immediate sellout in a matter of a few minutes with no approval process by the advertiser.

The present invention allows advertisers to purchase spot radio on an unwired network basis. The present invention automates the buying and research elements by infusing market research data, as well as through the database supplied by Radio DataTrak. The present invention creates a viable return on investment model.

With regard to broadcast companies, the present invention delivers new radio advertisers that can utilize radio effectively to generate an acceptable return on investment. The present invention delivers an automated stream of revenue by selling perishable inventory, generated within seconds of expiration. The present invention places the control of local inventory into the hands of the local decision makers. If market conditions do not allow the sale of the discounted media, the station does not need to accept it. Schedules are pre-emptible.

The present invention provides a massive increase in revenues to large media groups and more profitable revenues, by removing the cost of sale component of sales person commissions.

### EXAMPLE 1

If the company sells 1,000 worth of product from 60 commercials that cost $15 each. If the goal is a 1.5:1 the offer to the radio station is $12.50.

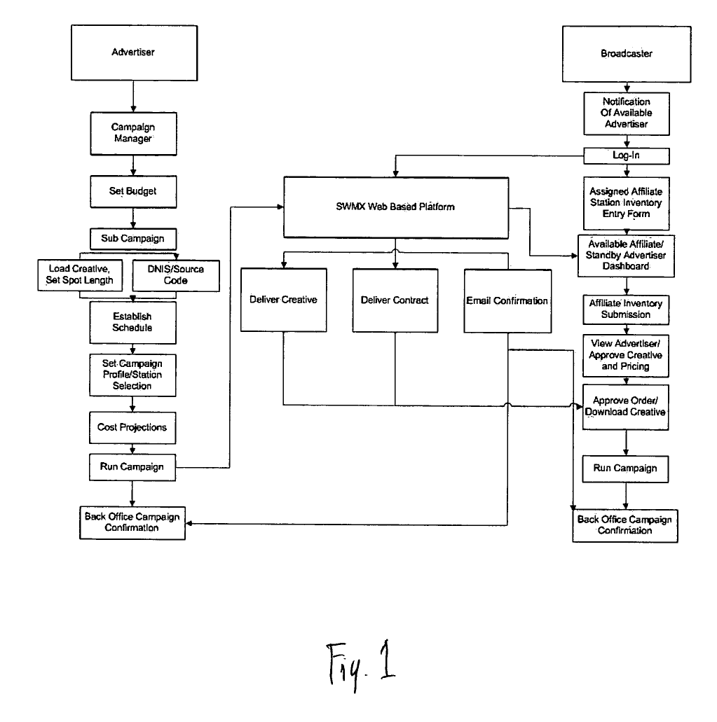

FIG. 1 shows a flow chart illustrating an embodiment of the present invention. The flow chart shows two simultaneous actions being performed, one by the broadcaster and one by the advertiser. The advertiser goes on to the web based platform, on to the campaign manager. The campaign manager is the web based tool which allows the advertiser establishes the criteria for their advertising campaign. In the campaign manager the advertiser establishes a budget for the campaign. They then set up the parameters for their individual campaign. In the sub campaign, the advertiser loads the commercial creative, and establish the length of the commercial they are interested in buying. The advertiser puts in a source code if they would like to track their advertisement. Once this is completed the advertiser moves on to their established schedule box, in which they input their days of the week and time of day they would like to advertise. The advertiser then moves to the set campaign profile/station selection. Either by demographic, designated market area or format, they establish the media they would like to purchase. Once they have selected the parameters of their campaign they will be given cost projections by the system of the present invention. The program then matches audience data against cost per 1000 to determine individual unit cost. The advertiser can then run their campaign. Once the advertiser runs their campaign the system of the present invention provides this information to the media providers, as a notification of available or potential advertiser. The Broadcaster logs into the system of the present invention. The Broadcaster will then see the media that has been assigned to them. The Broadcaster will be notified who is interested in advertising with them, and if they have available inventory, the input this information into the system, in different fields based about day and time of day. Once the information comes in regarding the fields from the Broadcaster, the system matches this to the information from the advertiser. The Broadcaster or media outlet can then view the advertiser's creative, and is able to use the pricing that the advertiser has initiated for each individual advertisement. If the pricing and creative are approved by the Broadcaster then the Broadcaster can download the actual commercial and contract. An email then notifies the advertiser and after the commercials have run, a final reconciliation is delivered to the advertiser, and the advertiser pays and the Broadcaster receives their payment.

1. A web-based tool for providing unused advertising space to a potential advertiser comprising:
a web-based tool that identifies unsold commercial inventory relating to advertising space;
said tool presenting offers to purchase unsold advertising to local sales management on a daily basis on behalf of it's advertisers;
said tool providing said advertiser on a daily basis information regarding what advertisement is running and where;
said tool providing said information via a wireless means, including but not limited to e-mail; and
said tool providing a return on investment report to said advertisers.

2. The tool of claim 1 wherein said tool fully automates sale of unused advertising space by incorporating research, delivering contracts, reconciliation of accounting process, tracking sales performance, and delivery of advertisement itself.

3. The tool of claim 1 wherein said tool is a web-based software interface utilizing a database platform which includes information on every licensed commercial radio station in the United States, powered Radio Data Trak and its parent M Street Corp.

4. The tool of claim 1 wherein said tool creates an infinite number of unwired networks of radio stations based on several different criteria specific to needs of said advertiser.

5. The web-based tool of claim 1 wherein said tool takes said unsold advertising space in radio, print, television, newspapers, billboards and similar unsold space and provides it to advertisers.

6. The web-based tool of claim 5 wherein with regards to radio or television, the advertisement is only available for distribution on stations that satisfy the criteria of the advertiser.

7. A method for providing unused advertising space to a potential advertiser comprising:
choosing markets an advertiser wishes to advertise in;
choosing demographics an advertiser wishes to advertise in;
choosing price an advertiser wants to pay for said advertising space;
creating a product profile for said advertiser based on said advertiser's product, target and return on investment;
matching said product profile with a station profile.

8. A method for providing unused advertising space to a potential advertiser comprising:
logging on to a website by a company selling advertising space;
viewing offer and product shown by said advertiser;
comparing unsold time costs versus offered cost per thousand against target demo;
buying advertising that matches said costs and target demo.

9. The method of claim 8 wherein said method is used for radio or television stations.

10. The method of claim 8 further comprising:
printing an order;
downloading produced creative or script from said web site; and
airing said creative.

11. The method of claim 10 further comprising:
providing advertisers with invoices; and
examining affidavits created by the media distribution centers.

12. The method of claim 11 further comprising:
providing complete results analysis to advertiser.

13. A method for providing unused advertising space to a potential advertiser comprising:
creating a market profile for an advertiser;
determining a prospective list of places to which said advertiser can offer to buy remnant, unsold, or perishable advertising inventory;
determining by said advertiser a rate per thousand (CPM) based on viewers, listeners, subscribers or participants that they are willing to pay for unsold advertising inventory;
offering to said places an applicable rate meeting their market profile;
receiving an email notifying sales management of said place that a prospective client is interested in purchasing their unsold advertising inventory; and
requesting sales management to log-on with their unique user name and password. Once sales management agrees to the rate offered on behalf of the advertiser.

14. The method of claim 13 further comprising:
establishing by web database provider, said place can sell their unsold inventory, download said advertisement, print contract for order.
